(19) United States
(12) Patent Application Publication
(10) Pub. No.: US 2025/0313031 A1
(43) Pub. Date: Oct. 9, 2025

(54) USE OF AT LEAST ONE DRYING VEGETABLE OIL AS AN ANTIVIRAL AGENT

(71) Applicant: OBERTHUR FIDUCIAIRE SAS, PARIS (FR)

(72) Inventors: Henri ROSSET, LE PIN (FR); Marine DABERT, LA MURETTE (FR); Flavien LOZANO, SASSENAGE (FR)

(21) Appl. No.: 18/865,824

(22) PCT Filed: May 16, 2023
(86) PCT No.: PCT/EP2023/063180

§ 371 Date: Nov. 14, 2024

(30) Foreign Application Priority Data
May 17, 2022 (FR) FR2204685

(51) Int. Cl. B42D 25/36; B42D 25/29; C09D 5/14; C09D 7/40; C09D 11/06; C09D 11/101

(52) U.S. Cl. CPC B42D 25/36; B42D 25/29; C09D 5/14; C09D 7/40; C09D 11/06; C09D 11/101

(57) ABSTRACT

At least one siccative vegetable oil with an iodine value of at least 80 gI/100 g for giving antiviral properties to a deposit formed on the surface of an inert substrate.

### TECHNICAL FIELD

The invention relates to the field of inks and varnishes such as those known as oxidative drying inks and varnishes, notably for printing. In particular, the invention relates to the field of surface treatment of an article, in particular of a substrate such as a printable substrate, notably in sheet form, and more particularly a treatment intended to give this article antiviral properties.

### PRIOR ART

In modern societies, an ever increasing quantity of materials or objects, such as supports for transmitting information, is intended to be handled daily and frequently by a large number of people.

As non-limiting illustrations of these information supports, mention may notably be made of means of payment, such as a bank note, a cheque or a restaurant ticket, an identity document, such as an identity card, a visa, a passport or a driving license, a lottery ticket, a transport ticket, a tax disc or tax stamp, a playing card, a packaging, a book, a magazine, etc.

However, the users of these objects may be carriers of pathogenic microorganisms, in particular viruses, which may generate epidemic and pandemic diseases with varying degrees of severity, and may therefore be liable to contaminate any support with which they come into contact. In the case where this support is intended to be subsequently handled by one or more other users, it in turn becomes an important vehicle for the dissemination of microorganisms, with respect to other people.

For example, as a medium of exchange in commercial transactions, banknotes are one of the most widely handled information supports in the world and therefore represent a potential vector for the transmission of diseases.

Many solutions exist involving inorganic or synthetic biocides that can be used to treat substrates so as to provide antimicrobial protection. However, these manufactured biocidal compounds may be relatively toxic and are also often expensive.

The development of technical solutions using environmentally friendly biocidal active agents is thus becoming an important issue at a time when environmental and ecological considerations, notably with regard to recyclability, govern the choice of certain technologies, in particular when it comes to biocidal active agents which by their nature are generally harmful to the environment and are subject to significant restrictions notably with regard to their release.

In addition, antimicrobial protection techniques are often of such a nature as to substantially modify the surface appearance of the material to be protected. For example, the techniques of applying active-agent protective films or the use of copper-based metallic coatings substantially modify the initial thickness and/or colour of the substrate.

It should also be noted that many of the techniques used for the implementation of antimicrobial protection are not compatible with mass production due to their complexity, notably with an impact on production rates and/or cost. For example, it is often necessary to implement an additional composition element or process step.

Moreover, for obvious reasons, optimizing the antiviral properties provided by a surface treatment on these supports is an ongoing objective. In particular, it is sought to achieve good antiviral efficacy while at the same time providing good broad-spectrum antimicrobial efficacy, notably good antibacterial efficacy.

The present invention is specifically directed towards proposing a solution for giving antiviral properties to a deposit formed on the surface of a substrate while at the same time overcoming the drawbacks mentioned previously.

In particular, the invention is directed towards a solution for forming an antiviral deposit on the surface of a substrate via conventional printing techniques, notably of the offset type.

It is also directed towards proposing an antiviral protection for articles, which is environmentally friendly and notably which does not alter the recyclability of said articles.

### DISCLOSURE OF THE INVENTION

The present invention thus proposes the use of at least one siccative vegetable oil with an iodine value of at least 80 gI/100 g to give antiviral, in particular virucidal, properties to a deposit formed on the surface of an inert substrate.

In particular, the siccative vegetable oil is used in the form of a varnish or an ink, notably intended to form a coating covering all or part of the surface of said inert substrate or a pattern printed on the surface of said inert substrate.

Preferably, the siccative vegetable oil is linseed oil, an oil derived from linseed oil or a mixture thereof.

It is understood that the intended use of the present invention is non-therapeutic.

Admittedly, varnishes or inks comprising linseed oil are known as environmentally friendly protective formulations. However, to the inventors' knowledge, it has never been proposed to use linseed oil for the purpose of providing antiviral activity to a deposit formed on the surface of an inert substrate, in particular in an oxidative drying varnish or ink intended to be printed via a conventional printing process such as offset printing.

Contrary to all expectations, the inventors have in fact discovered that siccative vegetable oils, in particular linseed oil, exhibit, when they form a deposit obtained after oxidative drying on the surface of a substrate, significant antiviral activity, notably broad-spectrum virucidal activity on naked and enveloped viruses.

Indeed, as emerges from the examples given hereinbelow, a substrate of the paper type coated with a deposit obtained from a composition comprising linseed oil as an emulsion in water shows excellent antiviral activity, both on a naked virus and on an enveloped virus.

Moreover, unlike solutions using synthetic biocides, the natural character and the absence of toxicity of the proposed solution, using a siccative vegetable oil or a derivative thereof as an antiviral agent, do not disrupt the recyclability of the treated material. Moreover, the siccative vegetable oil is an edible product and its use according to the invention may in certain configurations make it possible to produce coatings that are suitable for food contact.

The solution proposed in the present invention also has an economic advantage associated with the inexpensive active principle, i.e. the siccative vegetable oil, and with the possibility of forming thin deposits by means of the application process such as printing, notably of the offset, rotogravure, screen or flexographic type, preferably offset printing. In particular, the use of a varnish or ink that can be applied by printing, notably offset, rotogravure, screen or flexographic printing, preferably offset printing, makes this solution compatible with mass production.

For the purposes of the invention, the term “antiviral” refers to the ability of a compound, a deposit, a coating or an object such as a substrate, to inhibit the growth of viruses or to kill viruses.

The antiviral properties afforded by the siccative vegetable oil used according to the present invention are more particularly dedicated to inhibiting and/or killing viruses that are pathogenic to mammals and more particularly to humans.

Such viruses may be viruses lacking an envelope, known as “naked” viruses, which consist of a genome, DNA or RNA and a capsid of viral proteins, or viruses known as “enveloped” viruses, which additionally have an envelope consisting of a double lipid layer in which viral proteins are integrated.

As representatives of viruses that are pathogenic to humans and which may be considered according to the invention, mention may be made more particularly of retroviruses, cytomegaloviruses, rotaviruses, paramyxoviruses, polioviruses, hantaviruses, coxsackie viruses, encephalomyocarditis virus, picornaviruses, including rhinoviruses, and DNA or RNA viruses, notably the flaviviridae, AIDS virus, influenza viruses, notably H1N1, adenoviruses, coronaviruses, notably the human-infecting coronaviruses Hcov-229E, Hcov-OC43, SARS-COV-2, smallpox virus, yellow fever virus, hepatitis C virus, Ebola viruses, herpes viruses, Epstein-Barr virus, varicella-zoster virus, rubella virus, and simian virus 40 or SV40.

For the purposes of the invention, the term “virucidal” refers to the ability of a compound, a deposit, a coating or an object such as a substrate to kill viruses, notably as described above.

According to one particular embodiment, the present invention relates to a use of at least one siccative vegetable oil with an iodine value of at least 80 gI/100 g, to give antiviral properties against enveloped viruses, notably of the human-infecting coronavirus family, to a deposit formed on the surface of an inert substrate.

In particular, the enveloped viruses may be airborne enveloped viruses. These viruses may in particular be coronaviruses, in particular such as coronaviruses Hcov-229E, Hcov-OC43 or SARS-COV-2, or influenza viruses, in particular such as influenza A virus, influenza B virus, influenza C virus or influenza D virus.

In particular, the enveloped viruses may be RNA viruses, more particularly single-stranded RNA viruses, in particular positive-sense single-stranded RNA viruses.

According to another particular embodiment, the present invention relates to a use of at least one siccative vegetable oil with an iodine value of at least 80 gI/100 g, to give antiviral properties against naked viruses, notably of the adenovirus family, to a deposit formed on the surface of an inert substrate.

In particular, the naked viruses may be naked viruses responsible for gastroenteritis. These viruses may be rotaviruses, noroviruses, caliciviruses, adenoviruses or astroviruses.

Alternatively, the naked viruses may be DNA viruses, notably double-stranded DNA viruses.

Advantageously, the siccative vegetable oil according to the invention can provide antiviral properties against naked viruses, in particular responsible for gastroenteritis, and against enveloped viruses, in particular airborne viruses, to a deposit formed on the surface of an inert substrate. These viruses may be naked viruses and enveloped viruses such as previously described. In particular, the siccative vegetable oil according to the invention can provide antiviral properties against naked viruses of the adenovirus family and enveloped viruses of the human-infecting coronavirus family.

Other characteristics, variants and advantages of a use according to the invention, and of its implementation for the surface treatment of articles, in particular of substrates, will emerge more clearly on reading the following description and examples, given as non-limiting illustrations of the invention.

In the continuation of the text, the expressions “between . . . and . . . ”, “ranging from . . . to . . . ” and “varying from . . . to . . . ” are equivalent and are intended to mean that the limits are included, unless otherwise mentioned.

### DETAILED DESCRIPTION

As indicated previously, the invention uses at least one siccative vegetable oil to afford particularly advantageous antiviral properties. In particular, the siccative vegetable oil makes it possible to form an antiviral deposit on the surface of an inert substrate by oxidative drying.

### Siccative Plant Oil

For the purposes of the present invention, the term “vegetable” compound means a compound or extract of natural origin obtained from plants, via, where appropriate, one or more physical and/or chemical processes, for instance grinding, refining, distillation, purification, filtration or cooking.

The term “naturally occurring” compound refers to any compound which already exists in nature or which may be synthesized from naturally occurring compounds.

For the purposes of the invention, the term “siccative oil” is intended to denote an oil which, when spread out in a thin layer and then exposed to the air, becomes a solid film or solid layer.

The siccative vegetable oil used in the application is selected from vegetable oils rich in unsaturated fatty acids, which are notably monounsaturated and/or polyunsaturated, or esters thereof such as triglycerides. The term “unsaturated” fatty acid means that the fatty acid includes at least one carbon-carbon double bond. A “monounsaturated” fatty acid includes a single carbon-carbon double bond. A “polyunsaturated” fatty acid includes at least two carbon-carbon double bonds.

In particular, the siccative vegetable oil comprises at least 65% by weight, preferably at least 75% by weight, or even at least 85% by weight, of unsaturated fatty acids, esters thereof and mixtures thereof, relative to the total weight of the siccative vegetable oil. Preferably, the siccative vegetable oil comprises at least 65% by weight, more preferentially at least 75% by weight or even at least 85% by weight, of fatty acids chosen from oleic acid, linoleic acid, α-linoleic acid, esters thereof and mixtures thereof, in particular from oleic acid, linoleic acid, α-linoleic acid and mixtures thereof, relative to the total weight of the siccative vegetable oil.

The siccative properties of an oil may be characterized by its iodine value. The iodine value represents the amount of iodine that is capable of bonding to the unsaturations borne by the vegetable oil, and is expressed in grams of iodine per 100 g of vegetable oil. Thus, the higher the iodine value, the more siccative the oil. For example, the iodine value of a saturated fatty acid is zero. The iodine value may in particular be determined by titration according to the standard NF EN ISO 3961.

The siccative vegetable oil used in the application according to the invention has an iodine value of at least 80 gI/100 g. In particular, the siccative vegetable oil has an iodine value of at least 100 gI/100 g, preferably at least 150 gI/100 g.

Advantageously, the siccative vegetable oil may be chosen from linseed oil, Chinese wood oil, also known as Tung or Canton oil, oiticica oil, vernonia oil, poppy seed oil, pomegranate oil, calendula oil, rapeseed oil, sunflower oil, hemp oil, soybean oil, castor oil, lavender oil and peppermint oil, in particular from linseed oil, Chinese wood oil, oiticica oil, vernonia oil, poppy seed oil, pomegranate oil, calendula oil, sunflower oil, hemp oil and soybean oil; oils derived therefrom such as esters of these vegetable oils, alkyd resins obtained from these vegetable oils; and mixtures thereof.

Alkyd resins are polyesters comprising hydrocarbon-based chains of fatty acids, obtained notably by polymerization of polyols and polyacids or the corresponding anhydride thereof, in the presence of fatty acids. These fatty acids are present, notably in the form of triglycerides, in the majority of natural oils, in particular such as the oils mentioned previously.

The term “derived oil” means a vegetable oil which has been modified by chemical reaction. In particular, the siccative vegetable oil may be refined and/or partially polymerized. In this respect, mention may be made of blown oils and stand oils, and maleinized, epoxidized or cooked oils.

According to a particularly preferred embodiment, the vegetable siccative oil according to the invention is linseed oil, an oil derived from linseed oil or a mixture thereof, preferably linseed oil. In general, linseed oil has an iodine value of 170 to 204 gI/100 g.

Linseed oil may be raw or cooked. Preferably, the siccative vegetable oil used in the application according to the invention is raw, refined, or refined and crystallized by cooling (known as “winterized”) linseed oil.

The term “cooked linseed oil” means raw linseed oil which has been heated to a high temperature, notably above 280° C., under controlled oxidation and then to a lower temperature. Such siccative vegetable oils are commercially available. For example, mention may be made of the linseed oils sold by the company Alberdingk Boley under the names “Crude LO”, “Refined LO”, “Refined LO winterized”, or “Pale refined LO”.

The siccative vegetable oil may be used in pure form, in the form of an emulsion or a solution. In particular, it is used in the form of an emulsion, notably an oil-in-water emulsion, or a solution in a solvent. As a solvent that is suitable for forming a vegetable oil solution, mention may be made of turpentine.

Preferably, the siccative vegetable oil is used in the form of an emulsion, notably oil in water, or even in the form of a dispersion, notably an aqueous dispersion.

According to a particular embodiment, the siccative vegetable oil may be used as an emulsion, notably an aqueous emulsion, or a dispersion, notably an aqueous dispersion, which may contain at least one polymeric binder, notably chosen from acrylic, polyurethane, styrene-acrylic binders, copolymers thereof and mixtures thereof.

Alternatively, the siccative vegetable oil may be used in a wax.

In particular, the siccative vegetable oil is used in the form of a formulation, such as a varnish, an ink or a lacquer, preferably a varnish or an ink, having a viscosity adapted to its application to the inert substrate by printing, notably a viscosity ranging from 30 mPa·s to 40 Pa·s, preferably from 50 mPa·s to 25 Pa·s. It may be used in the form of a formulation comprising from 0.5% to 75% by weight, preferably from 1.5% to 70% by weight, more preferentially from 30% to 70% and even more preferentially from 40% to 70% by weight, of siccative vegetable oil as considered according to the invention, notably linseed oil, relative to the total weight of the formulation.

Preferably, the siccative vegetable oil is used in the form of a varnish or an ink, notably an oxidative drying varnish or ink. In particular, the siccative vegetable oil is a predominant component of the varnish or ink. Firstly, it ensures the oxidative drying function of the ink or varnish and, secondly, it provides the associated antiviral, notably virucidal, function without requiring the use of additional synthetic biocides.

Preferably, the siccative vegetable oil is used in the form of a UV-radical-crosslinking or UV-cationic-crosslinking varnish. This crosslinking is initiated when the varnish or ink is applied to the surface of the support to be treated to produce the expected varnish film or printing deposit. Advantageously, the siccative vegetable oil possesses, in addition to antiviral activity, antimicrobial activity, in particular antibacterial and/or antifungal activity.

In particular, the varnish or ink can be applied at a low deposition rate, i.e. it allows the formation of deposits of small thickness and/or small surface area. Advantageously, it preserves the appearance of the surface of the substrate, i.e. the appearance of the surface is sparingly if at all modified by the application of the varnish or ink. According to an advantageous embodiment, the varnish or ink may be applied by a printing process, notably offset printing, rotogravure printing, screen printing or flexography, preferably by offset printing.

The varnish may be a pre-printing or post-printing varnish, notably an overprinting varnish, in particular an oxidative drying varnish. In particular, the varnish has a viscosity ranging from 30 mPa·s to 40 Pa·s, preferably from 50 mPa·s to 25 Pa·s.

The varnish may comprise from 0.5% to 75% by weight, preferably from 1.5% to 70% by weight, of siccative vegetable oil as considered according to the invention, notably linseed oil, relative to the total weight of the varnish. For example, it may be a varnish comprising at least 1% free linseed oil, the free linseed oil content being determined by transesterification, and having a dynamic viscosity at 40° C. of between 0.3 and 3.15 Pa·s at a shear rate of between 9 and 9320 s⁻¹, the viscosity being measured using a Haake dynamic viscometer. The term “free linseed oil” is intended to denote unpolymerized linseed oil.

The ink may be a printing ink, notably an oxidative drying printing ink. In particular, the ink has a viscosity of from 30 mPa·s to 40 Pa·s, preferably from 50 mPa·s to 25 Pa·s. The ink may comprise from 0.5% to 75% by weight, preferably from 1.5% to 70% by weight, more preferentially from 30% to 70% and even more preferentially from 40% to 70% by weight, of siccative vegetable oil as considered according to the invention, notably linseed oil, relative to the total weight of the ink.

The drying vegetable oil may be used in combination with at least one auxiliary agent, in particular chosen from auxiliary biocidal agents, surfactants and siccative agents, in particular in combination with at least one auxiliary biocidal agent, notably at least one auxiliary antiviral agent. The term “auxiliary agent” is intended to denote a compound different from the siccative vegetable oil used according to the invention. The siccative vegetable oil may also be used in combination with one or more additional compounds, notably with regard to its mode of application and its intended purpose.

The siccative vegetable oil may be used in combination with at least one security element, notably a marker or tracer, for example for the purpose of authenticating and/or identifying the composition comprising the siccative vegetable oil and/or the deposit formed. A marker or tracer may be in the form of an active element, particles or fibres, which are capable of generating a specific signal when these tracers are subjected to optronic, electrical, magnetic or electromagnetic excitation, or a thermal or chemical stimulus.

Among the auxiliary biocidal agents, mention may be made of bacteriostatic, bactericidal, fungistatic, fungicidal, yeasticidal and virucidal agents which are different from a siccative vegetable oil considered according to the invention.

Needless to say, these agents are moreover selected for their harmlessness to humans under the conditions of use according to the invention.

This or these auxiliary biocidal agent(s) may notably be chosen from p-[(diiodomethyl)sulfonyl]toluol, 3-iodo-2-propynylbutyl carbamate, methyl-1H-benzimidazol-2-yl carbamate, quaternary ammonium-based compounds, notably didecyldimethylammonium chloride (DDAC), monolaurin, compounds based on isothiazoline or isothiazolone derivatives, chitosan or chitin derivatives, zinc zeolite, silver ions, notably silver chloride, silver in supported particulate form and triclosan and mixtures thereof.

According to a variant, the siccative vegetable oil is used in combination with at least one bacteriostatic and/or bactericidal agent chosen from compounds based on chitosan or chitin derivatives, zinc zeolite, silver ions, silver in supported particulate form and triclosan and mixtures thereof.

According to a variant, the siccative vegetable oil is used in combination with at least one fungistatic and/or fungicidal agent chosen from compounds based on isothiazoline or isothiazolone derivatives, chitosan or chitin derivatives, zinc zeolite, silver ions, silver in supported particulate form and triclosan.

According to a variant, the siccative vegetable oil is used in combination with at least one fungistatic and/or fungicidal agent based on p-[(diiodomethyl)sulfonyl]toluol.

According to a variant, the siccative vegetable oil is used in combination with at least one fungistatic and/or fungicidal agent based on methyl-1H-benzimidazol-2-yl carbamate.

According to a variant, the siccative vegetable oil is used in combination with at least 3-iodo-2-propynylbutyl carbamate (IPBC).

According to another variant, the siccative vegetable oil is used in combination with at least one auxiliary antiviral agent, notably a virucide, in particular of natural origin.

The virucides of natural origin that may be used in the context of the present invention may thus be obtained either by extraction and purification from a natural medium containing them, or by synthesis from natural compounds.

By way of example of such virucides, mention may notably be made of monolaurin, which may be obtained by synthesis from glycerol and lauric acid.

For the purpose of the invention, the term monolaurin is intended to denote both naturally occurring monolaurin and that obtained synthetically from glycerol and lauric acid.

According to an embodiment, the naturally occurring virucide may notably be chosen from monolaurin, lactoferrin and essential oils with antiviral activity, for example essential oil of laurel.

Preferably, the siccative vegetable oil is used in a varnish or ink comprising less than 1% by weight, in particular less than 0.5% by weight, more particularly less than 0.1% by weight of auxiliary antiviral agent, notably virucide, or even free of auxiliary antiviral agent, notably virucide.

In particular, the siccative vegetable oil is used in a varnish or ink comprising less than 1% by weight, in particular less than 0.5% by weight, more particularly less than 0.1% by weight of auxiliary biocidal agent or is even free of auxiliary biocidal agent.

The surfactant may be chosen from nonionic, anionic, cationic and zwitterionic surfactants and mixtures thereof, preferably from nonionic surfactants. As examples of nonionic surfactants, mention may be made of fatty acid esters of sugars, fatty alcohol ethers of sugars, oxyalkylenated glycerol ethers, oxyalkylenated alcohols, fatty acid esters of polyethylene glycol, oxyalkylenated fatty acid esters of glycerol ethers, fatty acid esters of sorbitol, which are notably oxyalkylenated, silicone surfactants, copolymers of propylene oxide and ethylene oxide and mixtures thereof. Preferably, the surfactant is an ethoxylated surfactant such as beheneth-10.

The surfactant(s) may be used in a surfactant/siccative vegetable oil weight ratio ranging from 0.001 to 1, in particular from 0.01 to 0.15, more particularly from 0.05 to 0.1.

The term “siccative agent” means a compound which makes it possible to increase the drying power of a siccative oil, i.e. a siccative agent makes it possible to catalyse the drying of the siccative oil when the latter is exposed to the air.

In particular, the siccative agent may be chosen from metal salts, notably of cobalt, zirconium, zinc, manganese, for example metal salts of 2-ethylhexanoic acid, and mixtures thereof.

The siccative agent(s) may be used in a weight ratio of siccative agent(s)/siccative vegetable oil of from 0.001 to 1, in particular from 0.005 to 0.15.

### Inert Substrate

The siccative vegetable oil used according to the invention is intended to form an antiviral deposit on the surface of an inert substrate. In particular, it is intended to provide antiviral properties to said inert substrate.

The term “inert substrate” means herein a substrate made of inert material(s), i.e. non-living matter.

The inert substrate may be a porous and notably fibrous substrate.

It may be chosen from paper or cardboard type substrates, leather, wood, a textile or a non-woven fabric.

In particular, the inert substrate is different from wood, notably raw wood, chipboard or plywood. For example, the inert substrate is different from a raw wood or plywood, in particular a raw wood.

Preferably, the inert substrate is a printable substrate, i.e. a substrate intended for forming patterns and/or writing on its surface by printing.

Preferably, the inert substrate considered according to the invention is a paper or cardboard type substrate.

An inert substrate may be formed from fibres, which may be natural, artificial and/or synthetic. It may also contain mineral fillers.

According to an embodiment of the invention, the fibres used in the substrate composition comprise natural fibres.

Among the natural fibres, mention may be made of cellulose-based fibres, such as wood fibres, for example hardwood fibres, softwood fibres or mixtures thereof, cotton fibres, bamboo fibres, straw fibres, abaca fibres, asperto fibres, hemp fibres, jute fibres, linen fibres, sisal fibres and mixtures thereof.

The paper pulp used to form the paper or cardboard may be bleached, semi-bleached or unbleached, commonly referred to as bleached, semi-bleached or unbleached fibres, respectively.

Preferably, the fibres used in the substrate composition comprise cellulose-based fibres, in particular wood or annual plant fibres, synthetic fibres, and/or mineral fibres. According to a particular embodiment, the inert substrate is formed at least partly or even predominantly of cellulose-based fibres.

In particular, said cellulose-based fibres are a mixture of cotton fibres and wood fibres.

According to a particular variant, this substrate is formed at least partly or even substantially of recycled fibres, for example obtained from the pulping of waste paper.

According to another embodiment of the invention, the fibres used in the composition of the substrate may comprise synthetic fibres. The presence of synthetic fibres, mixed with cellulose-based fibres, in the substrate according to the invention makes it possible to improve the tear strength properties of said substrate.

In addition to these fibres, the porous and more particularly fibrous substrate may of course contain other components usually under consideration in the paper or cardboard industry and notably chosen from humectants, for instance polyol-type compounds, for instance glycerol, propylene glycol, polyethylene glycol, butylene glycol, glyceryl triacetate or sorbitol; fillers, notably mineral fillers such as colloidal silica, sodium silicates, sodium aluminosilicates, natural or precipitated calcium carbonates, talc, natural or calcined kaolin, alumina hydrate, titanium dioxide, aluminium silicates, barium sulfate, and mixtures thereof, or organic fillers such as plastic fillers or pigments; and anionic or cationic bulk bonding agents for example to develop some of the hydrophobicity of the finished substrate.

In particular, the inert substrate is chosen from sheet substrates for packaging or for the manufacture of information supports intended to be handled frequently by a large number of people, and therefore likely to carry pathogenic microorganisms, notably viral microorganisms. In particular, the inert substrate may be intended for the manufacture of an information support, such as a fibrous substrate intended for the manufacture of a security document. As examples of such security documents, mention may be made of banknotes, which are handled at least hundreds of times during their circulation period.

According to one embodiment, the inert substrate is dedicated to form a security sheet which incorporates at least one security element allowing the authentication of said sheet. In particular, said security element is chosen from visual devices, notably optically variable devices, known as OVDs, holograms, lenticular devices, interferential effect elements, in particular iridescent elements, liquid crystals, magnetically orientable effect pigments and interferential multilayer structures. These optically variable devices may be present on security threads embedded in the fibrous substrate or on strips or patches affixed to or printed on the fibrous substrate. As another visual security element, mention may also be made of watermarks made during the process of manufacturing the fibrous substrate. In particular, said security element is chosen from “luminescent” elements, which can be revealed under UV or IR light, these luminescent elements possibly being in the form of particles, fibrettes, planchettes, security threads at least partly incorporated into the fibrous substrate, or strips or patches affixed to or printed on the fibrous substrate. In particular, said security element is chosen from elements that can be detected automatically, notably optically or magnetically, these detectable elements, commonly called markers or taggants, being incorporated into the fibrous substrate or into visual or luminescent security elements. A security sheet may also include a radio frequency identification device, known as RFID, also providing an identification and traceability function to the security sheet.

According to one embodiment, the security sheet under consideration is or forms part of a security document. Preferably, the security document under consideration is an official document, in particular an identity document, a passport, a residence permit or a visa.

According to another embodiment, the inert substrate may be dedicated to form a driving license, an access card, a loyalty card, a photocopying card, a canteen card, a playing card, a collector's card, a means of payment, notably a payment card, a bank note, a voucher or a receipt, a ticket for access to cultural or sporting events, a certificate of authenticity, a book or a magazine.

The inert substrate may also be a cardboard dedicated to form packaging cartons, said cardboard being in particular formed from virgin fibres or preferably at least partly or even entirely from recycled fibres.

The inert substrate may also be a non-porous substrate, notably chosen from a metallic material, a ceramic, a glass, a plastic material and a paper/plastic hybrid substrate with the plastic part on the outside. In the case of a plastic material, this is, for example, a printable thin sheet of plastic, a packaging and/or protective film, a security foil, a laminate or a security element, or a polymer note.

According to a particular embodiment, the inert substrate, which is notably porous or non-porous, is suitable for the manufacture of an information support, such as a secure document, preferably a banknote.

In particular, the inert substrate, which is notably porous or non-porous, is dedicated to form a security sheet which incorporates at least one security element as described previously, allowing the authentication of said sheet, or a radio frequency identification device. In particular, the security sheet under consideration is or forms part of a security document. The security document under consideration may be an official document, in particular an identity document, a passport, a residence permit or a visa. The inert substrate may be dedicated to form a driving license, an access card, a loyalty card, a photocopying card, a canteen card, a playing card, a collector's card, a means of payment, notably a payment card, a bank note, a voucher or a receipt, a ticket for access to cultural or sporting events, a certificate of authenticity, a book or a magazine.

### Deposit

In the use according to the invention, the siccative vegetable oil is used to give antiviral properties to a deposit formed on the surface of an inert substrate.

This deposit may be obtained by application of at least one siccative vegetable oil according to the invention on the surface of the inert substrate to be treated.

Preferably, the deposit is formed by oxidative drying.

An oxidative drying step allows the siccative vegetable oil deposited on the inert substrate to solidify, notably by polymerization in the presence of oxygen.

Oxidative drying may be performed under an oxygenated atmosphere, notably comprising more than 10%, for example more than 20% by volume of oxygen. For example, it may be performed in the presence of air.

The oxidative drying may be performed at a temperature above 50° C., for example ranging from 100° C. to 200° C.

In particular, the deposit may be formed by placing at least all or part of one of the outer surfaces of the inert substrate in contact with at least one siccative vegetable oil as considered in the present invention, followed by oxidative drying. A support may thus be obtained comprising an inert substrate and a deposit on the surface of said inert substrate.

The formation of the deposit may be performed according to different modes of application of the siccative vegetable oil.

According to one embodiment, the inert substrate is immersed in a solution or emulsion containing at least one siccative vegetable oil as considered according to the invention.

According to another embodiment, a solution or emulsion containing at least the siccative vegetable oil as considered according to the invention is sprayed onto the surface of at least one face of the inert substrate.

According to another embodiment, the coating of at least one of the external surfaces of the inert substrate is performed with a coating solution containing at least one siccative vegetable oil as considered according to the invention. The coating or covering may be done by an air knife system, a curtain coating, by a pencil, knife or doctor blade system, by rollers, in particular pre-measured, engraved or transfer rollers, by a size press, by an impregnator, or by a film transfer press (film press).

According to another embodiment, the process is performed by surfacing at least one of the external surfaces of the inert substrate with a surfacing bath containing at least one siccative vegetable oil as considered according to the invention.

According to another embodiment, the inert substrate, having been previously coated and/or surfaced, is printed, partially or completely on the surface, with an ink containing at least one siccative vegetable oil as considered according to the invention.

According to another embodiment, an overprint varnish containing at least one siccative vegetable oil as considered according to the invention is applied to at least one of the external surfaces of said inert substrate, which has notably been previously coated and/or surfaced and printed. This may be done by printing, notably offset, flexographic, rotogravure or screen printing, or by spraying. Preferably, it is an application by printing, and more preferentially by offset printing.

These embodiments are particularly advantageous in that their implementation is compatible with a conventional process for manufacturing an inert support such as a porous support, notably a fibrous support, notably of the paper type, i.e. concomitantly with the conventional manufacturing steps.

They thus advantageously do not require any additional steps other than those required for manufacturing the support.

Needless to say, these various methods for placing the siccative vegetable oil in contact with the external surface(s) of the inert substrate to be treated may, where appropriate, be combined. However, these combinations must be compatible with the manifestation, on the inert substrate, of the desired antiviral activity.

In particular, the siccative vegetable oil is placed in contact with said inert substrate by sizing, surfacing or impregnation.

According to a preferred embodiment, the deposit is formed by printing, by sizing, by surfacing or by spraying, in particular by printing, notably of the offset, flexographic, rotogravure or screen printing type, preferably by offset printing.

The deposit may be located on the surface of said substrate and/or in the superficial part of the thickness of the substrate. In particular, the deposit is located at least on the outer surface of said substrate, or even only on the surface of the substrate, in other words without penetrating the thickness of the substrate.

Preferably, the deposit is a coating covering all or part of the surface of said inert substrate. In particular, the deposit is a coating covering the entire surface of the inert substrate. The coating may be arranged on the surface of a printed inert substrate, notably to protect a pattern and/or printed writing, or between an inert substrate and a printed surface, notably as a printing surface. Preferably, the targeted deposition area for the varnish according to the invention is an area dedicated to be exposed to direct contact with the handler of the substrate treated according to the invention so as to guarantee to this handler a gain in safety.

The deposit may also be a print, in particular covering only a portion of the surface of the inert substrate, for example in the form of patterns or writing, said covered portion preferably being a part intended to be handled and/or touched.

In particular, the deposit obtained after drying consists of at least 40% by weight of a siccative vegetable oil considered according to the invention, a derivative thereof, notably as obtained after oxidative drying, or mixtures thereof, notably at least 60% by weight, more particularly at least 75% by weight, or even at least 90% by weight, relative to the weight of said deposit.

Preferably, the deposit obtained after drying consists of at least 40% by weight of linseed oil, a derivative thereof, notably as obtained after oxidative drying, or mixtures thereof, in particular at least 60% by weight, more particularly at least 75% by weight, or even at least 90% by weight, relative to the weight of said deposit.

The deposit may also comprise at least one auxiliary agent as described above, notably at least one auxiliary biocidal agent, at least one surfactant and/or at least one siccative agent. In particular, the deposit comprises less than 5%, notably less than 1%, for example less than 0.5% of auxiliary biocidal agent relative to the weight of said deposit, or is even free of auxiliary biocidal agent. Preferably, the deposit comprises less than 5%, in particular less than 1%, for example less than 0.5% of auxiliary antiviral agent, in particular auxiliary virucidal agent, relative to the weight of said deposit, or is free of auxiliary antiviral agent, or is free of auxiliary virucidal agent.

The antiviral properties of the deposit formed on the surface of an inert substrate, notably as detailed previously, may be evaluated according to standard methods, as described in the following examples, for example with respect to the human coronaviruses Hcov-OC43 and Hcov-229E (enveloped viruses representative of the family of coronaviruses to which SARS-COV2 belongs) or with respect to Adenovirus 10 (naked virus responsible for respiratory syndromes and occasionally gastroenteritis), according to the standard ASTM E 1053 or to the standard ISO 21702.

The use according to the invention makes it possible in particular to achieve excellent antiviral activity, notably with a more than 99.9990% reduction in the viral load in 5 hours. Advantageously, the deposit formed on the surface of the inert substrate also has mechanical properties suitable for protecting the substrate from mechanical damage. It may be transparent and/or glossy and/or coloured. In particular, it forms a protective layer on the surface of the substrate with respect to its environment. Thus, the presence of the siccative vegetable oil gives the deposit, in addition to the primary functionality of durability, an additional function of protection against microbial risk.

In a preferred embodiment, the inert substrate on the surface of which the deposit is formed is a fibrous substrate of paper for banknotes or security documents or a wrapping paper, or a copy paper or a cardboard support for the manufacture of packaging cartons, notably cartons dedicated to forming packaging cartons, in particular flat or corrugated packaging cartons. In particular, the use according to the invention is directed towards forming a printed substrate.

According to a preferred embodiment, said inert substrate is a paper and said siccative vegetable oil, notably linseed oil, is used in an amount of at least 0.5% by weight, preferably at least 1% by weight, more preferentially at least 1.5% by weight, or even 1.5% to 2.5% by weight of siccative vegetable oil, notably linseed oil, relative to the weight of the paper.

According to another preferred embodiment, said inert substrate is a cardboard and said siccative vegetable oil, notably linseed oil, is used in an amount of at least 0.5% by weight of siccative vegetable oil considered according to the invention, notably linseed oil, preferably at least 1% by weight, more preferentially at least 1.5% by weight, or even from 1.5% to 2.5%, by weight of siccative vegetable oil considered according to the invention, notably linseed oil, relative to the weight of the cardboard.

### Applications

The use according to the present invention may notably be implemented to prepare papers for coverings (kraft liner or test liner) and/or corrugated paper used in the composition of packaging cartons.

It may also be used to prepare a security document, notably a banknote.

In particular, it may be used to prepare papers and non-woven and textile materials, writing papers, coated papers and copy papers.

The use according to the present invention may notably be implemented to prepare polymeric films for packaging or for fiduciary applications, and also plastic loyalty or payment cards.

### EXAMPLES

### Materials and Methods

The following starting materials were used:
Linseed oil sold by the company Sigma-Aldrich under the name Linseed oil, with an iodine value ranging from 170 to 204 gI/100 g of linseed oil;
Surfactant: Beheneth-10 sold by the company BASF under the name Eumulgin BA10;
Dispersion of styrene-acrylic copolymers at 46-48% dry weight sold by DSM Coating Resins BV under the name NeoCryl A-2092;
Acrylic copolymer emulsion at 43-45% dry weight sold by DSM Coating Resins BV under the name NeoCryl A-1127;
Acrylic copolymer dispersion at 43-45% dry weight sold by DSM Coating Resins BV under the name Decovery SP-6200XP;
Cationic crosslinking UV varnish for paper supports sold by the company Sicpa, with a dry extract of 90-100%;
Cationic crosslinking UV varnish for polymeric supports sold by the company Sicpa, with a dry extract of 90-100%;
UV-crosslinking varnish with a dry extract of 90-100% sold by SunChemical under the reference Sun Flexo UV gloss CTG.

In the following examples, and unless otherwise indicated, the weight percentages are expressed as weight percentages of the commercial products.

### 1. Testing of the Antiviral Properties

The test of the antiviral activity against the human coronavirus Hcov-OC43 (enveloped virus representing the family of coronaviruses to which SARS-COV2 belongs), or against Adenovirus 10 (naked virus responsible for respiratory syndromes and occasionally gastroenteritis) is based on the standard ASTM E 1053. The test of the antiviral activity against the coronavirus Hcov-229E is based on the standard ISO 21702.

### Cell Culture Infectivity Test

Human coronavirus Hcov-OC43 was propagated and counted using the Most Probable Number (MPN) method, using the human ileocaecal colorectal adenocarcinoma cell line HCT-8 (ATCC CCL-244) as the host. The cells were grown in cell culture flasks.

For the counting, the virus was counted as infectious units according to the assay methodology described in Standard Method 9510 (APHA, 2012 equivalent to EPA/600/R-95/178 and EPA/600/4/84/013 updated).

Briefly, aliquots of a virus-containing sample were inoculated onto freshly prepared monolayers of HCT8 cells (approximately 90% confluence). The cells were then incubated in dMEM (Dulbecco's Modified Eagle's medium); 2% foetal calf serum medium (FBS, Mediatech, USA) at 35° C. and 5% CO₂ for 8-10 days. The cells were regularly monitored under the microscope for signs of degeneration. Cells showing signs of infectivity in the flasks (cytopathic effects, CPE) were counted as positive (+) and those without any CPE as negative (−). The most probable number of infectious viruses in a sample was then calculated using the MPNCALC software (version 0.0.0.23).

For the experiments, frozen virus stock (typically 1×10⁸ IU/ml) was rapidly thawed in a water bath at 35° C. The viral suspension contained 2% FBS and was diluted in phosphate buffer solution (PBS) and used within 15 minutes of thawing. The viral suspension was counted by making tenfold serial dilutions in PBS and then inoculated onto HCT8 cells as described above.

### Evaluation of Treated Paper Samples

The evaluation test was adapted from ASTM protocol E 1053 (“Standard Practice to Assess Virucidal Activity of Chemicals Intended for Disinfection of Inanimate, Nonporous Environmental Surfaces”).

Specifically, the test papers were cut into 25 mm square sections. Three sections of each of the treated test papers and two sections of a reference paper were placed in sterile 100 mm diameter Petri dishes. 100 ml of the viral suspension were applied uniformly to the surface of each of the paper sections to be evaluated; the inoculum was applied in 10 μL drops. The Petri dishes were covered and incubated for 5 hours at 20-22° C. in a biological safety cabinet. Then, each of the samples (three treated paper sections and two control sections) were transferred to a sterile 50 ml conical-bottomed centrifuge tube (Corning, USA) containing 10 ml of sterile D/E neutralizing broth.

The collected samples were placed on an orbital shaker and shaken at low speed for 15 minutes. Subsequently, tenfold dilutions of the suspensions were made in PBS. The number of viable (infectious) virus units in the samples was determined using the Most Probable Number (MPN) method described previously.

The percentage of “reduction in viral load”, also known as the percentage of “antiviral activity”, is defined as follows:

$$\% viral reduction = \frac{( {MPN}_{0} - {MPN}_{treated} )}{{MPN}_{0}} \times 100 \qquad [ Math 1 ]$$

where MPN is the average over the samples evaluated of the Most Probable Number of Viral Infectious Units determined as described previously, at t=0 immediately after deposition of the inoculum (MPN₀), and after a contact time of 5 hours, for the treated sample (MPN_{treated}).

The reduction in viral load, expressed in log, is defined as follows:

$$Log reduction in viral load = log ( {MPN}_{Treated} ) - log ( {MPN}_{Untreated} ) \qquad [ Math 2 ]$$

with MPN_{Treated} and MPN_{Untreated} the average over the samples evaluated of the Most Probable Number of Viral Infectious Units determined as described previously after a contact time of 5 hours, respectively for a sample treated in accordance with the invention and for the same untreated sample.

The same protocol is performed for Adenovirus 10 using the cell line corresponding to ATCC VR-1504 as host.

### 2. Testing of the Antibacterial Properties

These are characterized using the antibacterial control according to the standard NF EN ISO 20743:2013—Textiles, determination of antibacterial activity of textile products, transfer method, with the strains Escherichia coli (ATCC 8739) representative of Gram-negative bacteria and Staphylococcus aureus (ATCC 6538) representative of Gram-positive bacteria. They are characterized for an incubation time of 24 hours. Prior to testing, the control samples were steam sterilized for 20 min at 121° C.

The growth value is defined as follows:

$$Growth = log ( {C}_{24 h} ) - log ( {C}_{0 h} ) \qquad [ Math 3 ]$$

with C₀ₕ and C₂₄ₕ representing, respectively, the bacterial concentration at t=0 h and after 24 h of incubation expressed in CFU/mL.

The percentage reduction of the bacterial load is defined as follows:

$$\% bacterial reduction = \frac{( {C}_{24 h} - {C}_{0 h} )}{{C}_{0 h}} \times 100 \qquad [ Math 4 ]$$

### 3. Test for Evaluation of the Water Uptake

The purpose of this test is to determine the bath weight taken during the coating/surfacing step by weighing the paper before and after coating/surfacing without drying. It is expressed in grams of wet coating applied per unit area (m²) or as a weight percentage.

### Example 1

### Compositions According to the Invention

Test 1: Linseed Oil Combined with a Dispersion of Styrene-Acrylic Copolymers

200 g of Neocryl A-2092 are stirred using a Rayneri disperser.

Linseed oil is added to the dispersion with stirring, in the amounts shown in the table hereinbelow.

The resulting mixture is stirred for 5 minutes and stirring is then stopped to observe the mixture at rest.

The mixture is collected and applied by coating on Kraft liner with a Braive 8 μm coating bar.

The compositions tested are listed in the table below, along with their quality in terms of appearance. The appearance of the film they form on a kraft support is also given.

TABLE 1

| | Composition 1 | Composition 2 | Composition 3 |
|---|---|---|---|
| | Weight % | Weight % | Weight % |
| Neocryl A-2092 | 99 | 98 | 97 |
| [% cial] | | | |
| Linseed oil | 1 | 2 | 3 |
| Mixture appearance | No incompatibility | No incompatibility | No incompatibility |
| | Only one phase | Only one phase | Only one phase |
| Layer appearance | No greasy marks on | No greasy marks on | No greasy marks on |
| on Kraft | the layer | the layer | the layer |

Test 2: Linseed Oil Combined with an Acrylic Copolymer Emulsion

200 g of Neocryl A-1127 are stirred using a Rayneri disperser.

Linseed oil is added to the dispersion with stirring, in the amounts shown in the table hereinbelow.

The resulting mixture is stirred for 5 minutes and stirring is then stopped to observe the mixture at rest.

The mixture is collected and applied by coating on Kraft liner with a Braive 8 μm coating bar.

The compositions tested are listed in the table below, along with their quality in terms of appearance. The appearance of the film they form on a kraft support is also given.

TABLE 2

| | Composition 4 | Composition 5 | Composition 6 |
|---|---|---|---|
| | Weight % | Weight % | Weight % |
| Neocryl A-1127 | 99 | 98 | 97 |
| [% cial] | | | |
| Linseed oil | 1 | 2 | 3 |
| Mixture appearance | No incompatibility | No incompatibility | No incompatibility |
| | Only one phase | Only one phase | Only one phase |
| Layer appearance | No greasy marks on | No greasy marks on | No greasy marks on |
| on Kraft | the layer | the layer | the layer |

Test 3: Linseed Oil Combined with an Acrylic Copolymer Dispersion

200 g of Decovery SP-6200XP are stirred using a Rayneri disperser.

Linseed oil is added to the dispersion with stirring, in the amounts shown in the table hereinbelow.

The mixture is stirred for 5 minutes and stirring is then stopped to observe the mixture at rest. The mixture is collected and applied by coating on Kraft liner with a Braive 8 μm coating bar.

The compositions tested are listed in the table below, along with their quality in terms of appearance. The appearance of the film they form on a kraft support is also given.

TABLE 3

| | Composition 7 | Composition 8 | Composition 9 |
|---|---|---|---|
| | Weight % | Weight % | Weight % |
| Decovery SP-6200 | 99 | 98 | 97 |
| [% cial] | | | |
| Linseed oil | 1 | 2 | 3 |
| Mixture appearance | No incompatibility | No incompatibility | No incompatibility |
| | Only one phase | Only one phase | Only one phase |
| Layer appearance | No greasy marks on | No greasy marks on | No greasy marks on |
| on Kraft | the layer | the layer | the layer |

Test 4: Linseed Oil in Combination with Three Commercial Varnishes

200 g of cationic crosslinking UV varnish for paper supports sold by the company Sicpa are stirred using a Rayneri disperser.

Linseed oil is added to the varnishes with stirring in a proportion of 5% linseed oil relative to the weight of the varnish.

The resulting mixture is stirred for 5 minutes and stirring is then stopped to observe the mixture at rest.

The same protocol is followed using the cationic crosslinking UV varnish for polymeric supports sold by the company Sicpa instead of the cationic crosslinking UV varnish for paper supports sold by the company Sicpa, to form a second mixture.

The protocol described above is also followed using Sun Flexo UV gloss CTG instead of the cationic crosslinking UV varnish for paper supports sold by the company Sicpa, and by adding 2% linseed oil instead of 5% relative to the weight of varnish, to form a third mixture.

The three liquid mixtures are homogeneous.

Each mixture is collected and applied by coating on Kraft liner with a Braive 8 μm coating bar. The drying of the three mixtures is not disturbed and the three deposits thus obtained are homogeneous non-oily films.

In conclusion, linseed oil does not show any incompatibility with the emulsions, dispersions and varnishes tested.

### Example 2

Preparation of a Paper Treated with Linseed Oil and Evaluation of the Antiviral Activity

Composition 10 as shown in Table 4 below is prepared by mixing the various compounds in water (addition of Eumulgin BA10 at 60° C. and then heating to 80° C.), followed by emulsification of the mixture of linseed oil, water and Eumulgin BA10 by rapid stirring using a Rayneri disperser for a few minutes.

TABLE 4

| | Composition 10 |
|---|---|
| | Weight % |
| Linseed oil (%) | 6.97 |
| Water qs | 100 |
| Eumulgin BA10 (%) | 0.50 |

The substrate under consideration for the treatment is a sheet of raw cotton paper free of surfacing, which may be suitable as paper for making banknote paper.

The substrate is impregnated in one pass on a sizing press with composition 10, then dried in an oven for 10 minutes at 105° C. to remove the water, and then left to dry at room temperature and under an ambient atmosphere.

A test A was performed.

The results of the antiviral activity, obtained as described above for the substrate treated with composition 10, are collated in Table 5 below, for an MPN₀ value of 1.1×10⁶.

TABLE 5

| | | Untreated |
|---|---|---|
| | Test A | substrate |
| Treatment composition | Composition 10 | — |
| Water uptake (%) | 27.7 | — |
| Oil content in the paper % | 1.94 | 0 |
| Reduction in viral load (%) | 99.9998 | 97.5 |
| (Hcov-OC43) | | |
| Log reduction in viral load | 4.14 | N/A |
| (Hcov-OC43) | | |
| Reduction in viral load (%) | 99.993 | 99.8 |
| (Adenovirus 10) | | |
| Log reduction in viral load | 1.44 | N/A |
| (Adenovirus 10) | | |

The virucidal activity of the treated substrate of Test A is excellent.

### Example 3

Preparation of a Paper Treated with a Commercial Linseed Oil-Based Varnish, and Evaluation of the Antiviral and Antibacterial Activities

Five substrates identical to the one used in Example 2 are considered.

The oxidative drying varnish (varnish 11) used in this example is a commercial solvent-free fat varnish. Its free (unpolymerized) linseed oil content, measured by the GC/FID method after transesterification by quantification of methyl linolenate, is 1.77% by weight relative to the total weight of the varnish.

The oxidative drying varnish was applied to the surface of the substrates by offset printing using an IGT applicator at a rate of 2.4 g/m² (tests B to F).

The results of the antiviral activity and antibacterial activity, obtained as described above for the substrates treated with varnish 11, are collated in Tables 6 and 7 below, respectively. The antiviral activity is measured at a MPN₀ (most probable number of viral units) value of 1.4×10⁶ and the reduction in viral load is calculated. The antibacterial activity is measured for an inoculum concentration of 1.40×10⁶ CFU/mL for S. aureus and 1.41×10⁶ CFU/mL for E. coli, on three specimens.

TABLE 6

| | | | | | | Untreated |
|---|---|---|---|---|---|---|
| | Test B | Test C | Test D | Test E | Test F | substrate |
| Reduction in | 99.99999 | 99.99997 | 99.99993 | >99.99999 | 99.99999 | 95.9 |
| viral load (%) | | | | | | |

The virucidal activity of substrates treated by offset printing with the linseed oil-based varnish 11 is excellent.

TABLE 7

| | | | | | Untreated |
|---|---|---|---|---|---|
| | | Specimen | Test B | Test F | substrate |
| S. aureus | Growth value | 1 | −1.78 | −4.25 | 1.27 |
| | (log) | 2 | −4.39 | −5.55 | (mean) |
| | | 3 | −5.39 | −3.85 | |
| | Reduction in | 1 | 98.35 | 99.994 | — |
| | bacterial load (%) | 2 | 99.996 | 100.00 | |
| | | 3 | 100.00 | 99.986 | |
| E. coli | Growth value | 1 | −3.39 | −5.11 | 3.11 |
| | (log) | 2 | −5.00 | −5.11 | (mean) |
| | | 3 | −4.00 | −1.55 | |
| | Reduction in | 1 | 99.96 | 100.00 | — |
| | bacterial load (%) | 2 | 100.00 | 100.00 | |
| | | 3 | 99.99 | 97.16 | |

Tests B and F show bactericidal activity.

### Example 4

Linseed Oil in Combination with Two Commercial Varnishes, Application to Paper and Evaluation of the Antiviral and Antibacterial Activities

### Test 1: Direct Contact Acrylic Varnish

200 g of direct contact acrylic varnish sold by the company S.N. Brancher are stirred using a Rayneri disperser.

Linseed oil is added to the dispersion with stirring in the content indicated in the table hereinbelow.

The resulting mixture is stirred for 5 minutes and its quality in terms of appearance is then examined at rest. The mixture is then taken up and applied by coating onto printing-writing paper on both sides with a coating bar so as to obtain a dry deposit of 2 g/m² and the appearance of this deposit is also characterized. All these observations are detailed in Table 8 hereinbelow.

TABLE 8

| | Composition 11 |
|---|---|
| Direct contact acrylic | 98 |
| varnish [% cial] | |
| Linseed oil | 2 |
| Mixture appearance | No incompatibility. Only one phase |
| Coating appearance on | No greasy traces on the coating |
| printing-writing paper | |

The results of the antiviral activity and antibacterial activity, obtained as described above for the substrates treated with the above varnish, are collated in Tables 9 and 10 below, respectively. The antibacterial activity is measured for an inoculum concentration of 1.72×10⁶ CFU/mL for S. aureus on three specimens.

TABLE 9

| | | | Test 1 | Varnish only |
|---|---|---|---|---|
| | | | (composition | applied to the |
| | | Specimen | 11) | substrate |
| S. | Growth value | 1 | −1.46 (mean) | −0.92 |
| aureus | (log) | 2 | | −0.13 |
| | | 3 | | −1.44 |
| | Reduction of | 1 | 96.49 (mean) | 88.06 |
| | the bacterial | 2 | | 25.18 |
| | load [%] | 3 | | 96.40 |

The antiviral activity is measured for an MPN₀ (most probable number of viral units) value of 8×10³ and the reduction in viral load is calculated.

TABLE 10

| | | Varnish only applied |
|---|---|---|
| | Test 1 (Composition 11) | to the substrate |
| Reduction in viral | 99.98 | 87.41 |
| load [%] | | |

The virucidal activity of the substrates with the varnish formulated with linseed oil is excellent.

### Test 2: Acrylac MGA Varnish

200 g of Acrylac MGA sold by the company Huber are stirred using a Rayneri disperser. Linseed oil is added to the dispersion with stirring in the content indicated in the table hereinbelow.

The resulting mixture is stirred for 5 minutes and the stirring is then stopped to observe the mixture at rest. The mixture is then taken up and applied by coating onto printing-writing paper on both sides with a coating bar so as to obtain a dry deposit of 3.5 g/m² and the appearance of this deposit is also characterized. All these observations are detailed in Table 11 hereinbelow.

TABLE 11

| | Composition 12 |
|---|---|
| Acrylac MGA varnish [% cial] | 98 |
| Linseed oil | 2 |
| Mixture appearance | No incompatibility. Only one phase |
| Coating appearance on | No greasy traces on the coating |
| printing-writing paper | |

The results of the antiviral activity and antibacterial activity, obtained as described above for the substrates treated with the above varnish, are collated in Tables 12 and 13 below, respectively.

The antibacterial activity is measured for an inoculum concentration of 1.73×10⁶ CFU/mL for S. aureus and 2.00×10⁶ CFU/mL for E. coli, on two specimens.

TABLE 12

| | | | Test 2 | | Varnish only |
|---|---|---|---|---|---|
| | | | (composition | | applied to the |
| | | Specimen | 12) | | substrate |
| S. | Growth value | 1 | −1.78 | (mean) | −1.52 (mean) |
| aureus | (log) | 2 | | | |
| | Reduction in | 1 | 98.36 | (mean) | 96.95 (mean) |
| | bacterial load (%) | 2 | | | |
| E. coli | Growth value | 1 | −4.56 | (mean) | −4.60 |
| | (log) | 2 | | | −2.90 |
| | Reduction in | 1 | 100 | (mean) | 100 |
| | bacterial load (%) | 2 | | | 99.87 |

The quantity of resulting viral units/cm² of affixed virus on the varnish alone applied to the substrate is 25119.

TABLE 13

| | | Varnish only applied |
|---|---|---|
| | Test 2 (Composition 12) | to the substrate |
| Reduction in | 36.9% | 0 |
| immediate viral load | | |
| (t = 0) [%] | | |
| Reduction in viral | 99.99% | 99.99% |
| load after 5 h of | | |
| contact [%] | | |

The virucidal activity of the substrates treated with the varnish according to the invention is characterized by a shorter duration of action.

### Example 5

Linseed Oil and Lavender Oil in Combination, Independently or Otherwise, with a Commercial Varnish Optionally Modified by Addition of Monolaurin, Application to Paper and Evaluation of the Antiviral Activities

50 g of SicpaProtect 889368 sold by the company Sicpa are stirred using a Rayneri disperser. Where appropriate, glyceryl monolaurate is incorporated into the varnish with stirring until fully dissolved.

Linseed oil and/or lavender oil is added to the dispersion with stirring in the content indicated in the table hereinbelow.

The resulting mixture is stirred for 5 minutes. The mixture is then taken up and applied by flexography onto note paper on both sides with an Anilox 7 so as to obtain a dry deposit of 2 g/m².

TABLE 14

| | Composition | Composition | Composition | Composition | Composition |
|---|---|---|---|---|---|
| | 13 | 14 | 15 | 16 | 17 |
| SicpaProtect 889368 | 100 | 99 | 95 | 95 | 95 |
| varnish [% cial] | | | | | |
| Glyceryl | 0 | 1 | 0 | 1 | 1 |
| monolaurate [% cial] | | | | | |
| Linseed oil | 0 | 0 | 5 | 4 | 4 |
| Lavender oil | 0 | 0 | 0 | 0 | 1 |

The results of the antiviral activity, for the substrates treated with the above varnish, are collated in Tables 15 and 16 below, respectively.

The antiviral activity against the coronavirus Hcov-229E is measured for an MPN₀ (most probable number of viral units) value of 3.98×10³ and the reduction in viral load is calculated.

TABLE 15

| | | Composition 13 |
|---|---|---|
| | Composition 15 | (varnish alone) |
| Reduction in viral | 92.06 | 68.38 |
| load [%] | | |

The antiviral activity against the coronavirus Hcov OC43 is measured for an MPN₀ (most probable number of viral units) value of 7×10⁵ and the reduction in viral load is calculated.

TABLE 16

| | Composition | | | |
|---|---|---|---|---|
| | 13 | Composition | Composition | Composition |
| | (varnish alone) | 14 | 16 | 17 |
| Reduction | 98.0 | 98.8 | 99.8 | 99.97 |
| in viral | | | | |
| load [%] | | | | |

The virucidal activity of linseed oil and lavender oil against the viruses Hcov-229E and Hcov OC43 of the substrates with the formulated varnishes is confirmed for this varnish.

1. A method of providing antiviral properties to a deposit formed on the surface of an inert substrate, using at least one siccative vegetable oil with an iodine value of at least 80 gI/100 g.

2. The method according to claim 1, wherein said antiviral properties being against naked viruses, notably of the adenovirus family.

3. The method according to claim 2, wherein said naked viruses being responsible for gastroenteritis.

4. The method according to claim 1, wherein said antiviral properties being against enveloped viruses, notably of the human-infecting coronavirus family.

5. The method according to claim 4, wherein said enveloped viruses being airborne viruses.

6. The method according to claim 1, wherein said method gives said deposit virucidal properties.

7. The method according to claim 1, wherein said deposit being a coating covering all or part of the surface of said inert substrate.

8. The method according to claim 1, wherein said deposit is formed by oxidative drying.

9. The method according to claim 1, wherein said siccative vegetable oil comprising at least 65% by weight of fatty acids chosen from oleic acid, linoleic acid, α-linoleic acid, esters thereof and mixtures thereof, relative to the total weight of the siccative vegetable oil.

10. The method according to claim 1, wherein said siccative vegetable oil is chosen from linseed oil, Chinese wood oil, also known as Tung or Canton oil, oiticica oil, vernonia oil, poppy seed oil, pomegranate oil, calendula oil, rapeseed oil, sunflower oil, hemp oil, soybean oil, castor oil, lavender oil and peppermint oil, oils derived therefrom such as esters of these vegetable oils, alkyd resins obtained from these vegetable oils; and mixtures thereof; an oil derived from linseed oil or a mixture thereof.

11. The method according to claim 1, wherein said deposit obtained after drying consisting of at least 40% by weight of said siccative vegetable oil, a derivative thereof or mixtures thereof, a derivative thereof or mixtures thereof, in particular at least 60% by weight, relative to the weight of said deposit.

12. The method according to claim 1, wherein said siccative vegetable oil being used in the form of an emulsion, or a solution in a solvent.

13. The method according to claim 1, wherein said siccative vegetable oil being used in an emulsion, or a dispersion, in particular containing at least one polymeric binder, polyurethane, styrene-acrylic binders, copolymers thereof and mixtures thereof.

14. The method according to claim 1, wherein said siccative vegetable oil being used in the form of a varnish or an ink.

15. The method according to claim 1, said siccative vegetable oil being used in the form of a UV-radical-crosslinking or UV-cationic-crosslinking varnish.

16. The method according to claim 1, wherein the siccative vegetable oil being used is in the form of a formulation comprising from 0.5% to 75% by weight, of said siccative vegetable oil, relative to the total weight of said formulation.

17. The method according to claim 1, comprising the step of placing said siccative vegetable oil in contact with said inert substrate by sizing, surfacing, or impregnation.

18. The method according to claim 1, wherein said deposit is formed by printing, by sizing, by surfacing, or by spraying, in particular by printing, flexographic, rotogravure, or screen printing type.

19. The method according to claim 1, wherein said inert substrate is a porous substrate.

20. The method according to claim 1, wherein said inert substrate is a non-porous substrate.

21. The method according to claim 1, for preparing a security document.

22. The method according to claim 1, wherein said inert substrate is a paper and said siccative vegetable oil is used in an amount of at least 0.5% by weight of siccative vegetable oil, relative to the weight of the paper.

23. The method according to claim 1, using said siccative vegetable oil in combination with at least one auxiliary agent.

24. The method according to claim 1, using the siccative vegetable oil in combination with at least one security element.
